(19) United States
(12) Patent Application Publication
(10) Pub. No.: US 2017/0360646 A1
(43) Pub. Date: Dec. 21, 2017

(54) EXOSKELETON AND METHOD OF OPERATION THEREOF

(71) Applicant: Luca Simone POLI, Quarona di Sesia (VC) (IT)

(72) Inventors: Luca Simone POLI, Quarona di Sesia (VC) (IT); Marco BUSSONE, Sostegno (BI) (IT)

(21) Appl. No.: 15/542,564

(22) PCT Filed: Oct. 28, 2016
(86) PCT No.: PCT/IB2016/056502

§ 371 Date: Jul. 10, 2017

(30) Foreign Application Priority Data
Nov. 2, 2015 (IT) 102015000068012

(51) Int. Cl. A61H 3/00; A61H 1/02

(52) U.S. Cl. CPC A61H 3/00; A61H 1/0262; A61H 2203/0431; A61H 2201/165; A61H 2201/1642; A61H 2205/10; A61H 2203/0406

(57) ABSTRACT

In an embodiment, an exoskeleton that can be applied to a limb of a wearer (P) includes a first member (12) and a second member (14) with an articulation (16) set in between to enable a relative movement of angular orientation of the first member (12) and of the second member (14) over a range of angular orientation. The exoskeleton (10) can likewise present at least one of the following features: —i) the second member (14) includes: —a first structure (14a), which can be oriented at the aforesaid articulation (16) with respect to the first member (12) over the entire said range of angular orientation; and —a second structure (14b), which can be coupled to the limb of the wearer (P) with a latch device (20) for latching the second structure (14b) to the first structure (14a), the latch device (20) being selectively disengageable at a certain angular position of the aforesaid range of angular orientation to render the first structure (14a) orientable with respect to the first member (14) independently of the second structure (14b); and/or —ii) the exoskeleton includes a distal end platform (22) coupled to the exoskeleton via a ball joint (18).

### TECHNICAL FIELD

The present description relates to exoskeletons.

By this term (or by the alternative, perhaps less appropriate, term “orthosis”) are defined devices that may be worn by a user, for example to favour locomotion by subjects who are prevented therefrom, even only temporarily.

Technological Background

Exoskeletons can be worn by the user, for example on one or more limbs with the purpose of enabling/facilitating a movement of articulation between the proximal branch and the distal branch of the limb with the function of delivering or removing motor energy, obtained for example via expressly provided motor drives.

The corresponding prior art comprises, for example, documents such as WO 2012/175211 A1, WO 2015/095211 A2, WO 2015/140352 A1, or WO 2015/140353 A2.

Notwithstanding a rather extensive activity of research in the sector, there is still felt the need to have available exoskeletons capable of adapting precisely to the characteristics of the wearer, preventing, for example, the operating modalities of the exoskeleton from possibly, at least in certain conditions, countering the possibilities of movement of the wearer.

### Object and Summary

The object of one or more embodiments is to contribute to providing a response to the above need.

According to one or more embodiments, this object is achieved with an exoskeleton having the characteristics recalled in the ensuing claims.

One or more embodiments may also refer to a corresponding operating method.

The claims form an integral part of the technical teaching provided herein in relation to one or more embodiments.

One or more embodiments may provide an exoskeleton system comprising a wearable articulated double structure (in practice, a pair of exoskeletons, a primary one and a secondary one), where the two structures are able to work synergistically for some aspects and separately for others.

One or more embodiments enable creation of a first structure that is able to perform, for example, the functions of ambulation and the changes of posture, whereas the second structure has the function of accommodating the person using it, guaranteeing respect of his or her functional limitations.

In one or more embodiments, the two structures can be joined so as to guarantee safety of the user, with the capacity of adapting to the degree of functional limitation of the latter.

In one or more embodiments, the secondary structure that receives the user, by separating from the primary structure, can enable the latter to complete a movement that the articulation of the person using the device could not perform, safeguarding the state of the articular districts that might be involved in damage.

One or more embodiments may envisage creation of an ankle comprising two structures, one with the function of enabling ambulation and the other that receives the user.

In one or more embodiments, the ankle of the primary structure may comprise a top (static) platform and a bottom (dynamic) platform connected by a hemisphere.

In one or more embodiments, the ankle of the secondary structure may comprise a platform capable of receiving the user. In one or more embodiments, the ankle of the primary structure in no way transfers movement to the ankle of the secondary structure, thus enabling use of the exoskeleton even by a person with serious articular limitations to the lower limbs.

### BRIEF DESCRIPTION OF THE DRAWINGS

One or more embodiments will now be described, purely by way of non-limiting example, with reference to the annexed figures, wherein:

FIGS. 1 and 2 are schematic illustrations of the operating criteria of an exoskeleton according to one or more embodiments;

FIG. 3 is a schematic perspective view of the structure of an exoskeleton according to one or more embodiments; and

FIGS. 4 to 6 illustrate possible details of embodiments.

It will be appreciated that, for clarity and simplicity of illustration, the various figures cannot be reproduced at the same scale.

### DETAILED DESCRIPTION

In the ensuing description, various specific details are illustrated aimed at providing an in-depth understanding of various examples of embodiments. The embodiments may be obtained without one or more of the specific details, or with other methods, components, materials, etc. In other cases, known structures, materials, or operations are not illustrated or described in detail so that various aspects of the embodiments will not be obscured.

Reference to “an embodiment” or “one embodiment” in the framework of the present description is intended to indicate that a particular configuration, structure, or characteristic described in relation to the embodiment is comprised in at least one embodiment. Hence, phrases such as “in an embodiment” or “in one embodiment” that may be present in various points of the present description do not necessarily refer to one and the same embodiment.

The references used herein are provided merely for convenience and hence do not define the sphere of protection or the scope of the embodiments.

In the figures, the reference number 10 designates as a whole an exoskeleton that may be worn by a user who finds himself limited, possibly even only temporarily, in performing motor activities.

For instance, in one or more embodiments, the exoskeleton 10 may comprise an articulated reinforcement that may be coupled to the body of the wearer P so as to set itself with one or more of its parts on one or more anatomical parts of the wearer P with the function of assisting the wearer P in carrying out motor and postural functions.

By way of example (and without this being open to interpretation in any sense limiting the embodiments), the figures of the annexed drawings refer to an exoskeleton 10 that may be worn on at least one of the lower limbs of the user P so as to comprise:
a first (proximal) member 12, which is to extend in an area corresponding to a thigh, hence in an area corresponding to the femur, i.e., of the proximal stretch of the limb; and
a second (distal) member 14, which is to extend at the calf, hence in an area corresponding to the tibia and the fibula, i.e., the distal stretch of the limb.

The first and second members 12, 14 are connected together through an articulation 16, which is to be located in a position corresponding to the knee and enables a movement of mutual angular orientation of the first member 12 and of the second member 14 within a certain range of angular orientation.

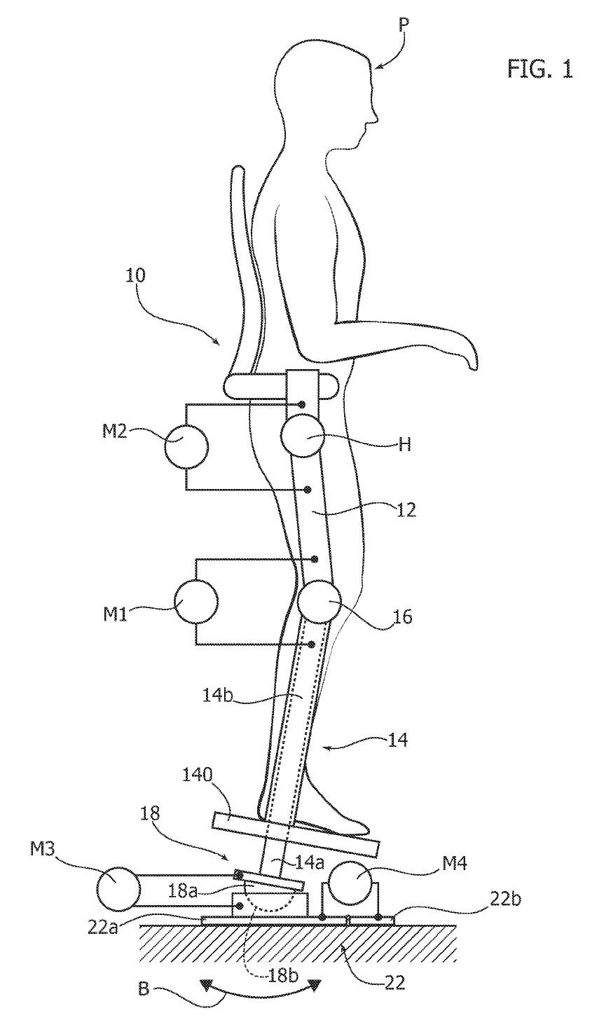

In the case of a normal limb, the range of angular orientation extends between a condition in which the proximal member 12 and the distal member 14 are approximately aligned with one another, forming with respect to one another an angle of approximately 180° (see, for example, FIG. 1) and conditions in which the distal member 14 forms with respect to the proximal member 12 an acute angle, for example in the region of 30° or less.

An exoskeleton of the type here considered may on the other hand comprise also other components.

For instance, the schematic representations of FIGS. 1 to 3 exemplify the possible presence of a further articulation H located in an area corresponding to the proximal end of the first member 12 (hence at the hip joint of the wearer), as well as a further articulation 18, which may function as ankle joint.

In one or more embodiments, the various articulations here considered may have associated respective motor drives M1, M2, M3, M4, which are able to govern in a positive way the relative movement of orientation of the elements connected by the articulation. These motor drives can be obtained according to known criteria and do not constitute in themselves a specific object of the embodiments.

One or more embodiments aim at taking into account the fact that, in one or more conditions of use (for example, with the wearer P sitting on a seat S) the relative movement of angular orientation between the first (proximal) member 12 and the second (distal) member 14 of the exoskeleton may attain angular values (for example, values of acute angle) not allowed by the articular districts of the wearer P, the wearer who, for various reasons, may experience a mobility of the limb (for example, of one or both of the lower limbs) that is limited to the condition in which the distal stretch (i.e., the calf) can be flexed with respect to the proximal stretch (i.e., the thigh) only through a limited angle.

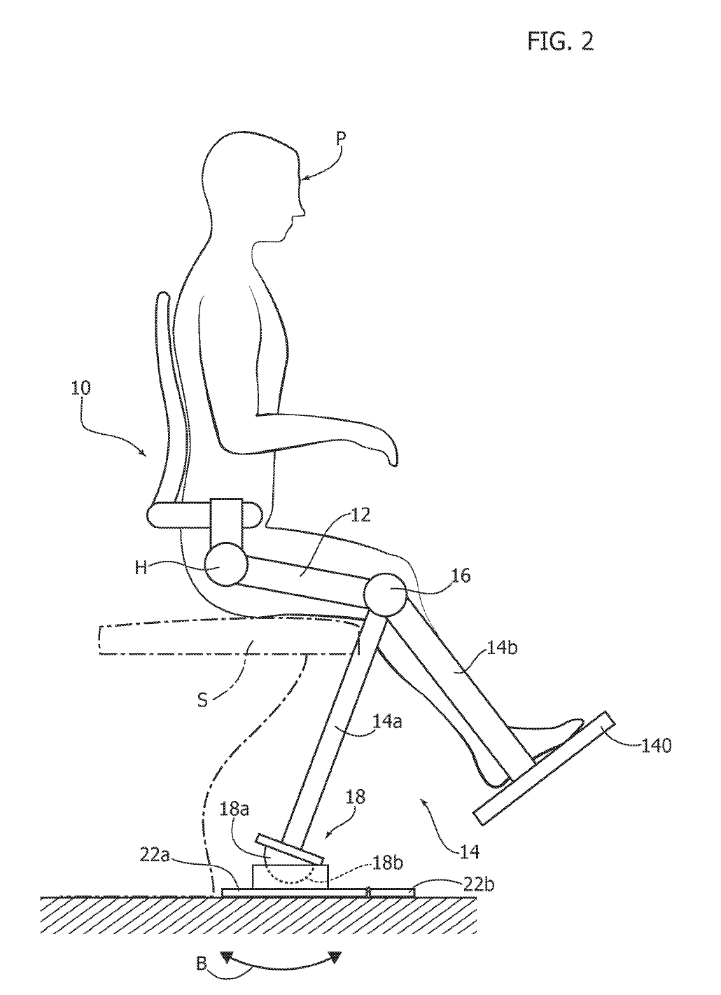

Such a condition is exemplified in FIG. 2 (where the motor drives M1, M2, M3, M4—which, on the other hand, are represented only schematically in FIG. 1—are not visible for simplicity of illustration).

One or more embodiments may envisage that the second (distal) member 14 of the exoskeleton 10 comprises a first structure 14a that can be oriented at the articulation 16 with respect to the first (proximal) member 12 over the entire range of angular orientation envisaged for operation of the exoskeleton, i.e., with a capacity of relative orientation that ranges practically from a flat or almost flat angle (as represented in FIG. 1 with reference to the upright stance) to an acute angle in the region of 50° or less (as exemplified in FIG. 2 with reference to the sitting condition).

One or more embodiments may envisage that the second (distal) member 14 of the exoskeleton 10 likewise comprises a second structure 14b, which can be coupled to the limb of the wearer (for example, with bands or straps, not visible in the figures).

One or more embodiments may then envisage a latch device 20, which can couple together the first structure 14a and the second structure 14b of the second (distal) member 14 of the exoskeleton 10.

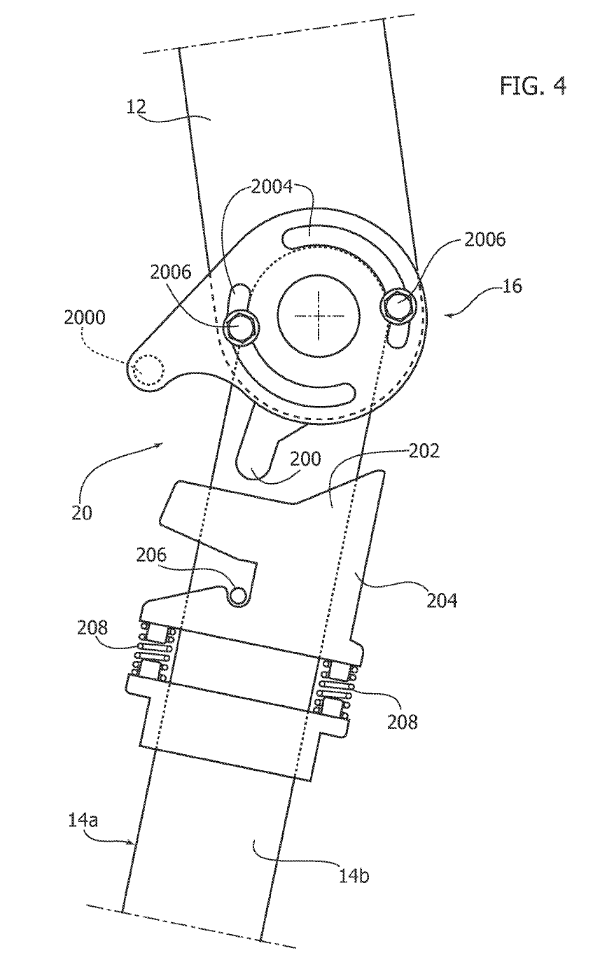

The latch device 20 (which may present the characteristics exemplified in FIGS. 4 to 6 and is not visible in FIGS. 1 to 3 so that the representation will not be too complicated) can be selectively uncoupled at a certain angular position of the range of relative orientation of the first and second members 12, 14 of the exoskeleton so as to be able to render the first structure 14a orientable with respect to the first member 12 independently of the second structure 14b.

In other words, with the latch device 20 in the engaged or coupling condition, the first structure 14a and the second structure 14b of the second member 14 of the exoskeleton are connected to one another and move together with respect to the first member 12, as may be required, for example, in conditions of upright stance, for example during ambulation (see FIG. 1).

When, instead, for example to enable the wearer P to sit down on a seat S, it is desirable that the exoskeleton 10 should “bend”, once a certain position of the relative movement of orientation of the first member 12 and of the second member 14 is reached (in particular, with a movement of bending that leads the two members in question to move in the direction such as to form an angle with respect to one another that gradually reduces), the latch device 20 can move into the uncoupling condition, “releasing” the second structure 14b from the first structure 14a in such a way that:
the structure 14a can proceed in its movement of orientation with respect to the first member 12 (so as to enable, for example, reaching of the sitting position represented in FIG. 2); and
the second structure 14b (coupled to the wearer's limb), being released from the first structure 14a, does not follow the first structure 14a in said movement of orientation beyond a certain angular position, and can thus maintain the wearer's limb in the condition of maximum bending that can be achieved.

In this way, the exoskeleton 10 does not force the limb of the wearer P towards conditions incompatible with the physiological conditions of the wearer.

In one or more embodiments, the second structure 14b may comprise a resting platform 140 fixed with respect to the second structure 14b, which is to receive the foot of the wearer P.

In one or more embodiments, in addition or as an alternative to the characteristics exemplified previously, it is possible to envisage that the exoskeleton 10 comprises, optionally carried by the first structure 14a of the second member 14, a ball joint 18 including a spherical head 18a that engages a socket or bowl 18b, which is also spherical, set on a terminal platform 22 of the exoskeleton so as to enable this platform to perform movements that are able, for example, to simulate the behaviour of an ankle, including inversion and eversion, enabling performance of motor and/or postural functions such as the ones exemplified in FIGS. 1 and 2, without the movements of the exoskeleton having any effect on the wearer P, with the possibility of performing said movements also to the benefit of a person with serious functional limitations to the limbs.

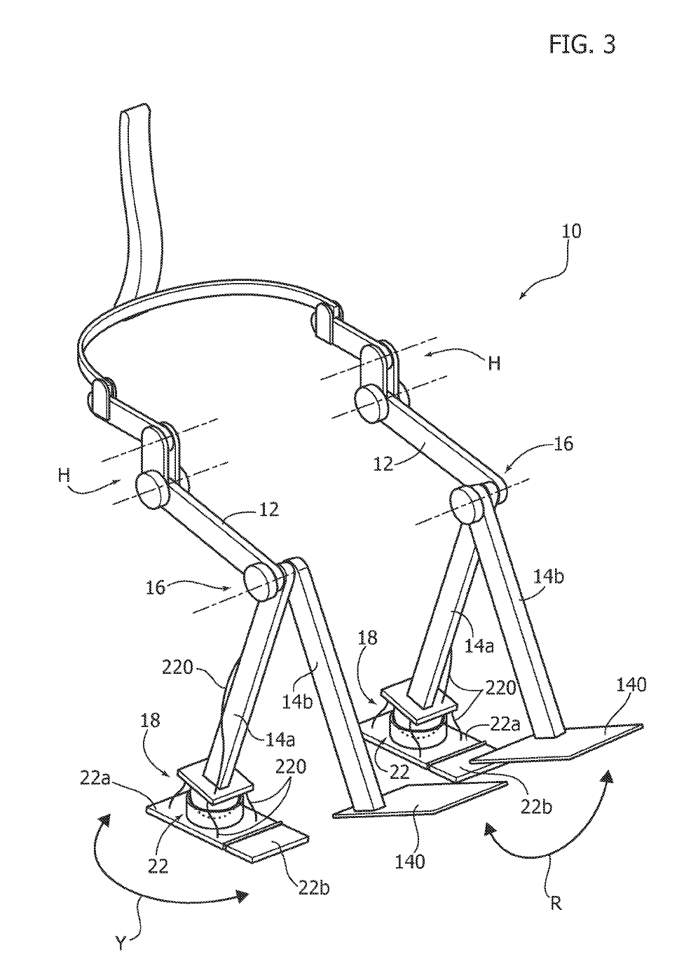

From the engineering standpoint, this may correspond to the fact of envisaging that the ball joint 18 can enable the platform 22 to perform, also in combination, movements of pitch (see the arrow B in FIGS. 1 and 2), roll (see the arrow R in FIG. 3), and yaw (see the arrow Y in FIG. 3) with respect to the remaining part of the exoskeleton.

In this regard, it will be appreciated that, even though the present detailed description refers, byway of example, to a lower limb, one or more embodiments are suited to being used together with an upper limb, with, for example, the articulation here exemplified by the articulation 16 that is to perform the function of the elbow joint or else of the shoulder joint of the wearer.

In the case of application to an upper limb, the platform 22 (and the corresponding ball joint 18) can hence enable the functions of orientation of the hand to be performed.

In this regard, it will be appreciated moreover that the arrangement of the ball joint 18 can, in one or more embodiments, be reversed with respect to the one exemplified herein, hence with the spherical head 18a carried by the platform 22 and the socket or bowl 18b carried by the remaining part of the exoskeleton, for example by the second member 14.

The representation of FIGS. 4 to 6 exemplifies possible criteria of implementation of the latch device 20 that is able to act between the two structures 14a, 14b of the second member 14 of the exoskeleton.

For instance, in one or more embodiments, the device 20 may comprise a cam mechanism, including a cam 200 carried, for example, by the first member 12 and a cam follower 202 carried by the second member 14 and carried by a moving element 204 which can co-operate in conditions of engagement with a pin 206, with the moving element 204 possibly elastically loaded (for example, via springs 208).

For instance, in one or more embodiments, it is possible to envisage that the pin 206 and the moving element 204 are carried, respectively, by the first structure 14a and the second structure 14b. In one or more embodiments, the kinematic arrangement may of course be reversed.

In one or more embodiments, the latch device 20 may be obtained so as to operate according to the direction of the relative angular movement of orientation between the first member 12 and the second member 14 of the exoskeleton 10.

In one or more embodiments, the relative movement of orientation may occur:
in a first direction, which leads to smaller angles between the first member 12 and the second member 14, i.e., with the exoskeleton that bends to enable/produce a movement of flexing of the limb of the wearer P; and
in a second direction, which leads to wider angles between the first member 12 and the second member 14, i.e., with the exoskeleton that extends to enable/produce a movement of extension of the limb of the wearer P.

For instance:
the first direction of movement is the one that leads from the condition exemplified in FIG. 1 to the condition exemplified in FIG. 2 (movement that enables sitting down, passing from the upright stance to a sitting condition); and
the second direction of movement is the one that leads from the condition exemplified in FIG. 2 to the condition exemplified in FIG. 1 (movement that enables standing up, passing from a sitting condition to the upright stance).

Operation of the cam mechanism exemplified in FIGS. 4 to 6 can hence occur according to the criteria described hereinafter.

When the first and second members 12, 14 (and the exoskeleton 10) are in the fully extended condition—FIG. 4—the cam 200 does not engage the cam follower 202. The moving element 204, possibly pushed elastically (via the springs 208), blocks the pin 206 so that the two structures 14a, 14b, mounted, respectively, on which are the moving element 204 and the pin 206, are blocked, i.e., latched, together and move together with respect to the first member 12.

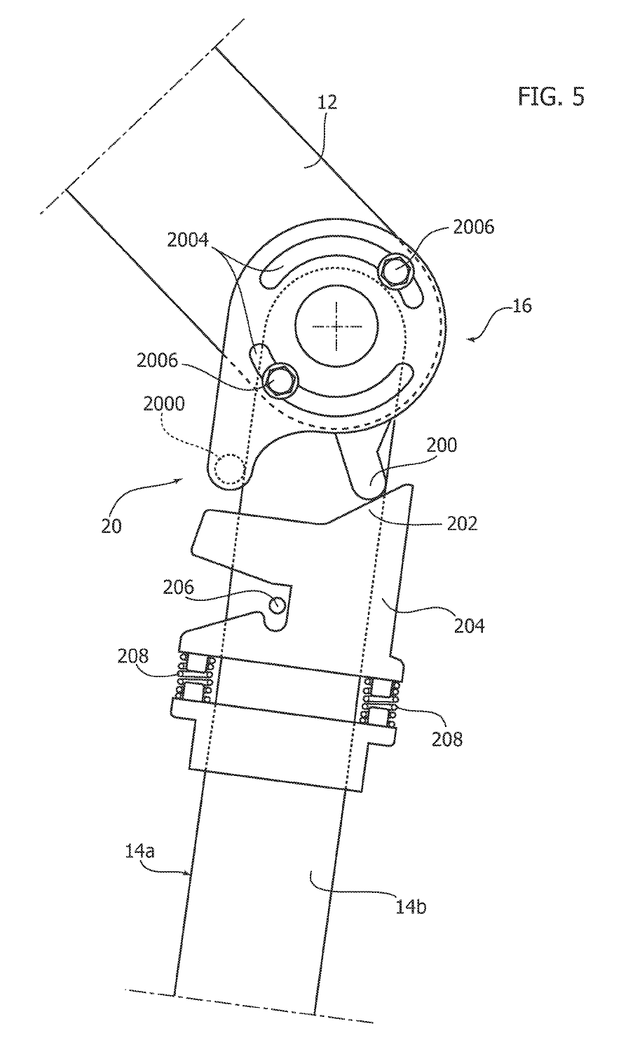

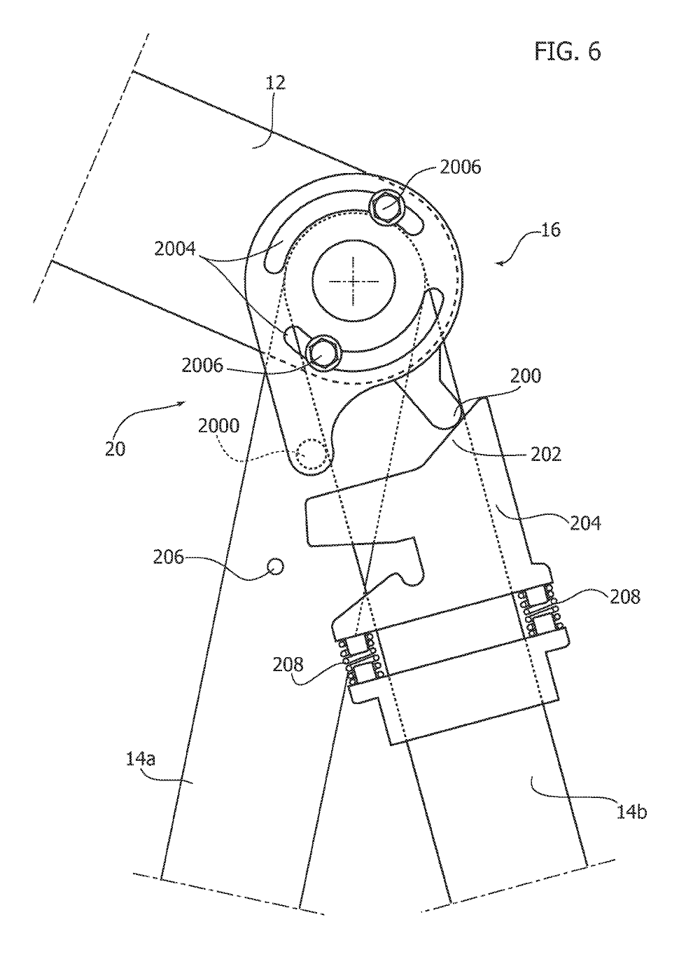

When, for example as a result of a movement of bending, the angle between the first member 12 and the second member 14 reduces, reaching a given angular value (possibly in a selectively variable way according to the characteristics of the wearer, for example according to the maximum angle of bending allowed by the wearer's limb, in line with the criteria exemplified in what follows), the cam 200 starts to engage the cam follower 202, bringing about gradual sliding of the moving element 204 (for example, against the force exerted by the springs 208) in such a way as to determine disengagement of the pin 206, as schematically exemplified by the sequence of FIGS. 5 and 6.

In the condition exemplified in FIG. 6, the two structures 14a and 14b of the member 14 are in effect released from one another so that the first structure 14a can proceed with the movement of orientation (for example, into the “sitting” condition of FIG. 2), whereas the second structure 14b, which is connected to the wearer's limb, remains in the limit angular position compatible with the conditions of the wearer.

Operation of the device 20 exemplified by the sequence of FIGS. 4 to 6 may be performed in the opposite direction, i.e., according to an opposite angular movement, for example to pass from the sitting condition of FIG. 2 to the upright condition of FIG. 1.

In this case, the structures 14a, 14b are initially released from one another (FIG. 6) and, as the exoskeleton 10 shifts towards the extended position, the structure 14a tends towards the second structure 14b, bringing about operation of the cam mechanism 20 according to modalities complementary to the ones described previously, hence (FIG. 5) going into the condition where the structures 14a, 14b are again engaged with one another so that they move together, being connected to one another, with respect to the first member 12 (condition represented in FIG. 4).

In one or more embodiments, it may be envisaged that the mechanism. 20 comprises an arrest element, for example, a pin 2000, such as to prevent, once there is disengagement from the structure 14a (which may proceed in the movement of bending with respect to the first member 12), the structure 14b from making any further movement in this direction.

In this way (as may be appreciated, for example, from FIG. 2), the aforesaid arrest element can support the structure 14b, which receives the wearer's limb, preventing any damage to the joint of the wearer himself.

In one or more embodiments, the cam 200 and/or the arrest element 2000 can be mounted in an adjustable way, for example by being arranged on a supporting plate, the angular position of which can be selectively modified, for example, by providing, in the aforesaid supporting plate, slits (eyelets) 2004 shaped like the arc of a circle, in which screws 2006 are inserted. By loosening the screws 2006 the plate can be made to turn so as to modify the angular position of the cam 200 and/or of the element 2000 with respect to the load-bearing element (for example, the first member 12). In this way, it is possible to select the angular position of relative orientation between the first member 12 and the second member 14, where there is obtained (for example, according to the modalities exemplified previously) disengagement/engagement of the mechanism 20 and/or the effect of arrest (support of the limb) by the element 2000.

It will be appreciated that the operating modes just described are not prevented, but rather facilitated by the ball joint 18, which is able, for example, to ensure orientation of the platform 22 in the various conditions of orientation and of relative connection of the other portions of the exoskeleton.

It will likewise be appreciated that, in one or more embodiments, the platform 22 may comprise a main body 22a, associated to which is the ball joint 18, and an articulated portion 22b (at the front, in the example here considered) that can be oriented with respect to the main body 22a, for example, under the action of the motor drive designated as a whole by M4 in just FIG. 1. This division (and movement) of the platform 22 may enable, for example, reproduction of the movement of bending of the foot (raising and lowering of the toes), which can further facilitate ambulation assisted by the exoskeleton.

Again, in one or more embodiments, the platform 22 may have associated (for example, as part of the motor drive designated by M3 in FIG. 1) flexible orientation wires 220, which are able to co-operate with the ball joint 18 during reproduction of the natural movements (for example, of the ankle or of the hand, according to whether the exoskeleton here exemplified is applied to a lower limb or an upper limb).

Of course, without prejudice to the underlying principles, the details of construction and the embodiments may vary, even significantly, with respect to what has been illustrated herein purely by way of non-limiting example, without thereby departing from the sphere of protection, as this is defined in the annexed claims.

1. An exoskeleton that can be applied to a limb of a wearer, the exoskeleton including a first member and a second member with an articulation set in between to enable a relative movement of angular orientation between the first member and the second member over a range of angular orientation, the exoskeleton presenting at least one of the following features:
i) said second member includes a first structure, which can be oriented, at said articulation, with respect to said first member over the entire said range of angular orientation, and a second structure, which can be coupled to the limb of the wearer with a latch device for latching the second structure to the first structure, said latch device being selectively disengageable at a certain angular position of said range of angular orientation to render said first structure orientable with respect to said first member independently of said second structure; and/or
ii) the exoskeleton includes a distal end platform coupled to the exoskeleton via a ball joint.

2. The exoskeleton according to claim 1, wherein said second member is set distally with respect to said first member.

3. The exoskeleton according to claim 1, wherein said distal end platform has at least one of the following features:
the platform is carried by said first structure of the second member;
the platform includes a main body coupled to said ball joint) and an articulated portion, preferably at the front, which is orientable with respect to said main body; and
the platform carries associated to it flexible orientation wires.

4. The exoskeleton according to claim 1, wherein, with said relative movement of angular orientation that admits of a first direction that leads to a reduction in the angle between said first member and said second member and a second direction that leads to an increase in the angle between said first member and said second member, the exoskeleton includes a mechanism that is sensitive to said movement of angular orientation and is configured for:
disengaging said latch device at said angular position when said movement is in said first direction and engaging said latch device at said angular position when said movement is in said second direction; and/or
arresting movement of said second structure with respect to said first member in said first direction at said angular position.

5. The exoskeleton according to claim 4, wherein said mechanism includes at least one between:
a cam actuator for disengaging or engaging said latch device at said angular position according to the direction of said relative movement of angular orientation; and
an arrest element, preferably a pin element, for arresting the movement of said second structure with respect to said first member in said first direction at said angular position.

6. The exoskeleton according to claim 4, wherein said mechanism is adjustable for selectively varying said angular position.

7. The exoskeleton according to claim 4, wherein said mechanism includes:
a cam carried by one between said first member and said second member and a cam follower carried by the other one between first member and said second member; and/or
a pin carried by one between said first member and said second member and acting against the other one (14b) between said first member and said second member.

8. The exoskeleton according to claim 1, wherein said second structure includes a resting platform fixed with respect to said second structure.

9. The exoskeleton according to claim 1, wherein said exoskeleton includes an exoskeleton for the lower limb with said articulation that may be located at knee joint of the wearer.

10. A method for operation of an exoskeleton according to claim 1, the method including selectively bringing said latch device into a condition of engagement or disengagement, at said certain angular position of said range of angular orientation.
